(19) United States
(12) Patent Application Publication
(10) Pub. No.: US 2013/0104387 A1
(43) Pub. Date: May 2, 2013

(54) ON PCB DIELECTRIC WAVEGUIDE

(71) Applicants: Yu Gang MA, Singapore (SG); Ching Biing Yeo, Singapore (SG); Hisashi Masuda, Singapore (SG); Yaqiong Zhang, (US)

(72) Inventors: Yu Gang MA, Singapore (SG); Ching Biing Yeo, Singapore (SG); Hisashi Masuda, Singapore (SG); Yaqiong Zhang, (US)

(73) Assignee: Sony Corporation, Tokyo (JP)

(21) Appl. No.: 13/588,652

(22) Filed: Aug. 17, 2012

(30) Foreign Application Priority Data
Aug. 26, 2011 (SG) 201106265-0

(51) Int. Cl. H01P 11/00

(52) U.S. Cl. CPC H01P 11/003
USPC 29/601

(57) ABSTRACT

A method which relates to fabricating a dielectric waveguide (WG) on a PCB for RF communication between ICs on the PCB. The WG can replace a baseband copper bus and resulting in the PCB being smaller and/or cheaper. The WG may be printed, stamped, cut or prefabricated onto the PCB.

### CROSS-REFERENCE TO RELATED APPLICATIONS

This application claims the benefit of priority under 35 U.S.C. §119 from Singapore Patent Application Number 201106265-0, filed on Aug. 26, 2011. The entire contents of the above application is incorporated herein by reference.

### FIELD OF INVENTION

The present invention relates to chip-to-chip RF communications on a PCB and an on-PCB dielectric waveguide.

### BACKGROUND

Copper tracks are typically used for chip-to-chip communications on a printed circuit board (PCB). However, the copper tracks have limited bandwidth for data transmission. Moreover, the energy expended is increased when the data transmission rate increases. Copper tracks may also be employed in a parallel configuration between the chips. This may increase the data transmission rate and avoid channel loss difference at low frequency and high frequency, but the power consumption may be even higher.

Parallel copper tracks also result in a large footprint, requiring the use of a large circuit board. Thus, it may be difficult to have a compact and sleek casing using parallel copper tracks.

Alternatively, parallel-to-serial conversion can also be carried out using a pair of copper tracks. However, this alternative still suffers from high power consumption for high data transmission rate applications.

### SUMMARY

In general terms the invention relates to fabricating a dielectric waveguide (WG) on a PCB for RF communication between integrated circuits (ICs) on the PCB. This may have the advantage that the WG can replace a baseband copper bus and thus the PCB can be smaller and/or cheaper. The WG may be printed, stamped, cut or prefabricated onto the PCB.

In a specific expression of the invention there is provided a method for providing chip-to-chip RF communications on a PCB, the method including providing a dielectric waveguide made from a dielectric material, and connecting a coupler at each end of the dielectric waveguide for coupling the dielectric waveguide to at least two chips.

### DESCRIPTION OF FIGURES

In order to ensure that the embodiments of the invention may be fully understood and readily put into practical effect, there is provided, by way of non-limitative example-only embodiments, the following illustrative figures which are referenced by the foregoing description.

FIG. 1 is a schematic diagram of a system for chip-to-chip RF communications of an embodiment;

FIGS. 2(a) to (e) are examples of cross-sectional shapes of a dielectric waveguide of an embodiment of the present invention;

FIG. 3 is a plan view image of the coupler shown in FIG. 1;

FIG. 4 is a schematic side view of the coupler of FIG. 3;

FIG. 5 is a process flow chart for a first method of forming a dielectric waveguide;

FIG. 6 is a process flow chart for a second method of forming a dielectric waveguide;

FIG. 7 is a process flow chart for a third method of forming a dielectric waveguide;

FIG. 8 is a schematic view of a PCB including a dielectric waveguide;

FIG. 9 is a graph of simulated propagation losses for the PCB of FIG. 8;

FIG. 10 is photograph of a PCB with a hand painted dielectric waveguide;

FIG. 11 is a plot of actual propagation losses for the PCB of FIG. 10;

FIG. 12 is an image of a PCB using copper tracks;

FIG. 13 is an image of a PCB using the system of an embodiment of the present invention;

FIGS. 14(a) to (d) is a diagram of examples of forming the dielectric waveguide;

FIG. 15 is a graph showing propagation losses of an on-PCB dielectric waveguide and a microstrip line (MSL);

FIG. 16 is a schematic view of a PCB without any dielectric waveguide;

FIG. 17 is a graph of simulated propagation losses for the PCB of FIG. 16;

FIG. 18 is a plan view image of the coupler shown in FIG. 1 coupled with a dielectric waveguide; and

FIG. 19 is a side view image of the coupler shown in FIG. 1 coupled with a dielectric waveguide.

### DESCRIPTION OF PREFERRED EMBODIMENTS

There is provided a system which facilitates chip-to-chip RF communications, whereby the system is implementable on PCBs with existing copper tracks. The system enables chip-to-chip RF communications on PCBs in place of copper track connections between the chips. There is also provided methods of incorporating a dielectric waveguide of the system on PCBs.

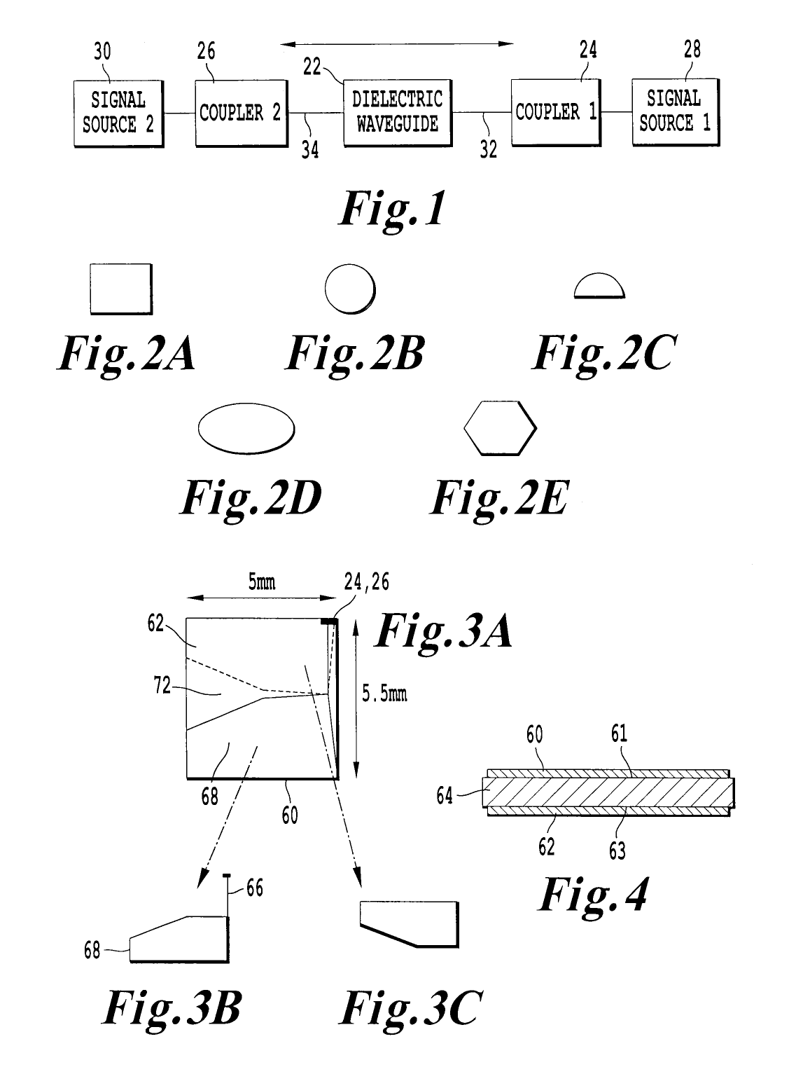

The system 20 is shown in FIG. 1 with a first signal source 28 being connected to a second signal source 30 via a dielectric waveguide 22 with couplers 24, 26 at respective ends 32, 34 of the dielectric waveguide 22. The sources 20, 30 may be integrated circuits or “chips”.

The on-PCB dielectric waveguide has a higher data bandwidth compared to transmission via copper tracks. The dielectric waveguide is typically a high pass channel with low channel attenuation. FIG. 15 is a graph showing propagation losses of an on-PCB dielectric waveguide and a microstrip line (MSL). It should be noted that the propagation losses of the dielectric waveguide is low for a wide range of frequencies compared to the increasing losses by the MSL as the frequencies increase. Although the MSL has high loss at high frequency, the loss is minimized at high frequency when the length of the MSL is small. Thus, it is possible to combine a short MSL and a dielectric waveguide and still have low propagation losses at a broad range of frequencies.

Referring to FIG. 1, there is provided the system 20 for chip-to-chip RF communications. It is appreciated that the system 20 may be incorporated on a PCB, whereby the PCB surface may be either a dielectric or a metallic layer. As such, the system 20 can be provided over either metal tracks on the PCB or a dielectric substrate. The system 20 may replace a conventional copper bus for chip-to-chip communications.

The system 20 includes a dielectric waveguide 22 made from a dielectric material. The dielectric material may be selected from, for example, Polytetrafluoroethylene (PTFE) or a composite material of PTFE and ceramic. Referring to FIG. 2, there are shown some examples of cross-sectional shapes of the dielectric waveguide 22. The dielectric waveguide 22 may have cross-sectional shapes like, for example, quadrilateral (FIG. 2(a)), circular (FIG. 2(b)), semi-circular (FIG. 2(c)), elliptical (FIG. 2(d)), and polygonal (FIG. 2(e)). It should be appreciated that the cross-sectional shapes may be determined by a process used to form the dielectric waveguide 22. In addition, the cross-sectional shape should allow the dielectric waveguide 22 to adhere to the PCB surface.

The system 20 also includes a coupler 24, 26 at each end 32, 34 of the dielectric waveguide 22. Each coupler 24, 26 couples the dielectric waveguide 22 to a signal source 28, 30. The signal source 28, 30 may be a semiconductor chip. An intrinsic impedance of the dielectric material is matched to the output impedance of the coupler 24, 26. The impedances of the coupler 24, 26 and the dielectric material may be, for example, 50 ohms. The impedances of the coupler 24, 26 and the dielectric material should be matched. The coupler 24, 26 and the dielectric material of the dielectric waveguide 22 have substantially similar high pass frequency responses. The dielectric waveguide 22 has high pass characteristics with a cut-off frequency being dependent on a cross-sectional area of the dielectric waveguide 22. Referring to FIGS. 3 and 4, each coupler 24, 26 includes two metal layers 60, 62 and a PCB substrate 64 located between the two metal layers 24, 26. It should be appreciated that the dimensions of the coupler 24, 26, denoted in FIG. 3, are merely illustrative and should not be taken to be restrictive. The coupler 24, 26 may be either a discrete module on the PCB or a part of an IC chip. Thus, the coupler 24, 26 can be added after fabrication of a PCB.

A first metal layer 60 at a first face 61 of the PCB substrate 64 of the coupler 24, 26 may be in a form of a polygonal shape (an asymmetrical pentagon is shown) when viewed in a plan view as shown in FIG. 3(b). The first metal layer 60 includes a MSL which is coupled to a contact of the signal source 28, 30 and transitions to a planar horn antenna 68. The planar horn antenna 68 is also high pass. A spanning angle of the two metal paths of the planar horn antenna 68 should be controlled to obtain an identical cut-off frequency as the dielectric waveguide 22, which is desirable when matching the planar horn antenna 68 to the dielectric waveguide 22. A distal edge 72 of the first metal layer 60 away from the MSL 66 may denote a planar horn-like transmission region of the coupler 24, 26.

A second metal layer 62 (as shown in FIG. 3(c)) at a second face 63 of the PCB substrate 64 acts as a ground plate for the coupler 24, 26 and does not overlap with the first metal layer 60. The metal used for the first metal layer 60 and the second metal layer 62 may include, for example, copper. The dielectric waveguide 22 is coupled to the coupler 24, 26 in a manner as shown in FIGS. 18 and 19, whereby the dielectric waveguide 22 includes an overlapping portion 19 for placement on the coupler 24, 26.

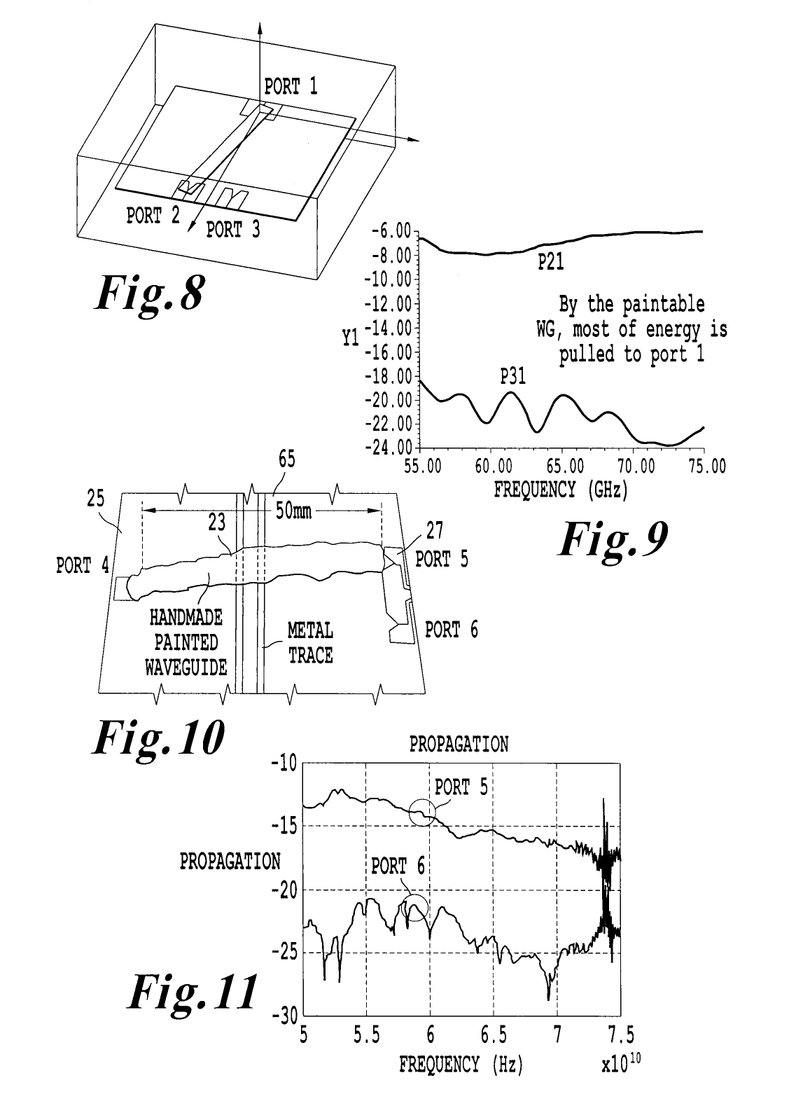

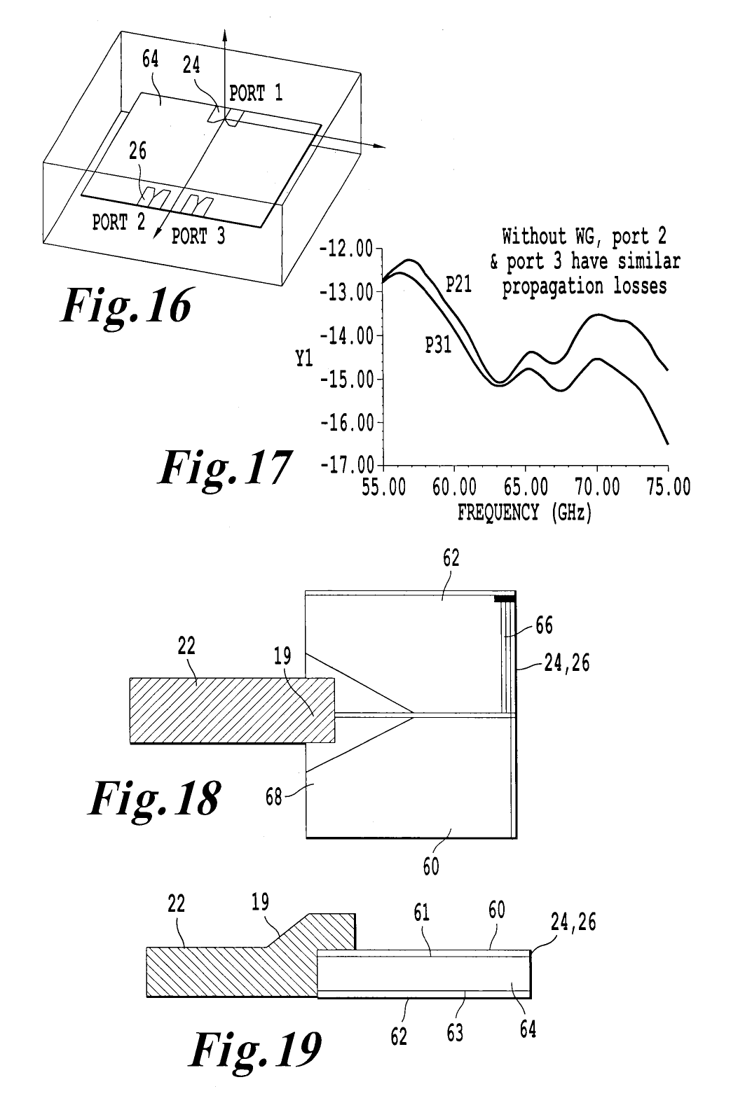

Referring to FIG. 8, there is shown a schematic view of the PCB 64 with the dielectric waveguide 22, with the couplers 24, 26. It should be appreciated that port 1 and port 2 in FIG. 8 are from signal source 1 (28) and signal source 2 (30), respectively. FIG. 9 shows a simulated plot of propagation losses for the PCB 64. The line “P21” shows a higher level of RF signal reception at port 2 from port 1 compared to the line “P31” which shows a lower level of RF signal reception at port 3 from port 1 (without the dielectric waveguide 22). As earlier simulation results, shown in FIG. 16 based on a setup shown in FIG. 15, have shown that propagation losses at port 2 and port 3 are similar in the absence of the dielectric waveguide 22 on the PCB 64, it is evident that the dielectric waveguide 22 minimizes propagation losses.

Referring to FIG. 10, there is shown a photograph of a plan view of a PCB 65 with a hand painted dielectric waveguide 23, with the couplers 25, 27. FIG. 11 shows a plot of actual propagation losses for the PCB 65. The line “Port5” shows a higher level of RF signal reception at port 5 from port 4 compared to the line “Port6” which shows a lower level of RF signal reception at port 6 from port 4 (without the dielectric waveguide 23). The mode of propagation in the dielectric waveguide 23 depends on a size of the dielectric waveguide 23 and a type of the couplers 25, 27. For example, a planar horn coupler results in TE mode propagation in the WG. In addition to minimizing propagation losses, it should be appreciated that using the system 20 may minimize electromagnetic interference and reduce power consumption compared to the use of copper tracks for chip-to-chip communications.

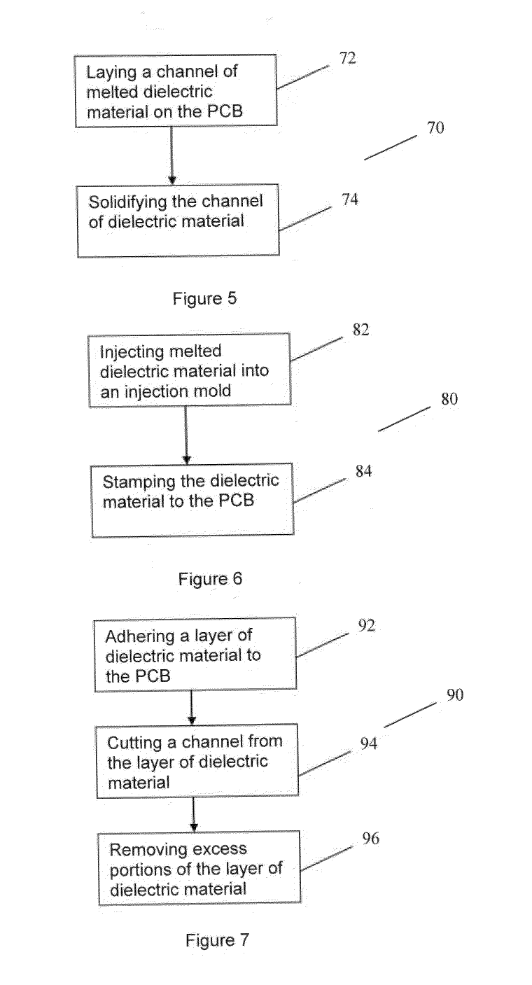

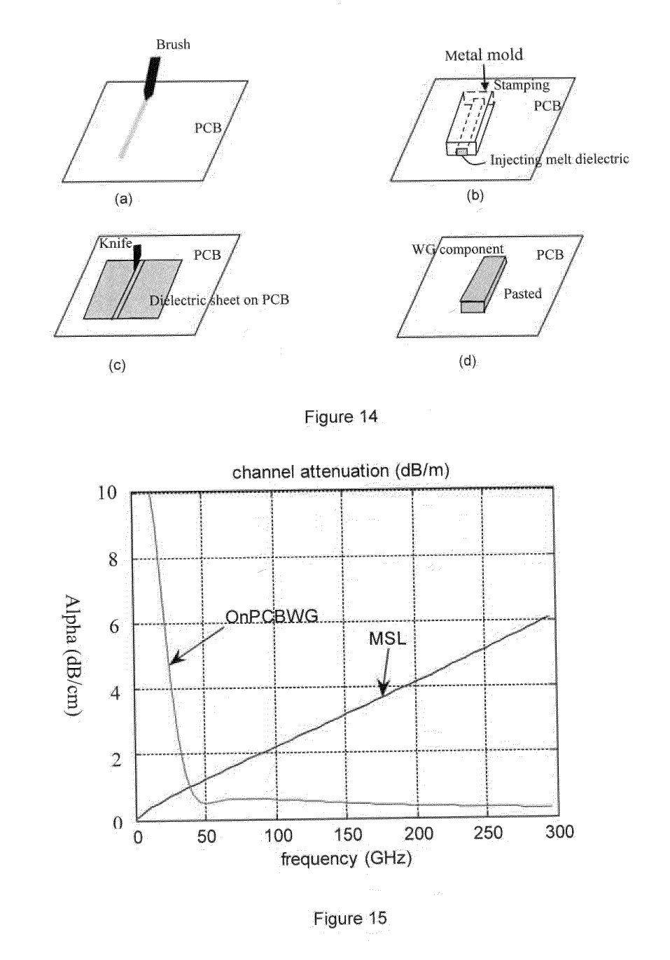

Referring to FIGS. 5 to 7, there are shown a plurality of methods for forming a dielectric waveguide 22 on a PCB. FIG. 5 shows a “printing” method 70 for forming the dielectric waveguide 22. The “printing” method 70 includes laying a dielectric waveguide 22 of melted dielectric material on the PCB (72), and solidifying the channel 22 of dielectric material (74). The dielectric material may be selected from, for example, PTFE, a composite material of PTFE and ceramic and so forth. It should be appreciated that the “printing” method 70 is low cost and versatile as a path of the dielectric waveguide 22 may be easily varied to connect various signal sources together. Furthermore, the dielectric 7 waveguide 22 also is able to be formed on existing copper tracks on any PCB. The “printing” method 70 is denoted graphically in FIG. 14(a).

FIG. 6 shows a process of an “injection stamping” method 80 for forming the dielectric waveguide 22. The “injection stamping” method 80 includes injecting melted dielectric material into an injection mold, the injection mold being for forming the dielectric waveguide 22 (82), and subsequently stamping the dielectric material to the PCB (84) with sufficient pressure to ensure a desired cross-sectional shape and an appropriate density. Furthermore, the channel 22 also is able to be formed on existing copper tracks on any PCB. The “injection stamping” method 80 is denoted graphically in FIG. 14(b).

FIG. 7 shows a process of a “cutting” method 90 for forming the dielectric waveguide 22. The “cutting” method 90 includes adhering a layer of dielectric material to the PCB (92), cutting the dielectric waveguide 22 from the layer of dielectric material (94), and removing excess portions of the layer of dielectric material (96). Furthermore, the dielectric waveguide 22 also is able to be formed on existing copper tracks on any PCB. The “cutting” method 90 is denoted graphically in FIG. 14(c).

It may also be possible to form the dielectric waveguide 22 on the PCB by either adhering or mounting the dielectric waveguide 22 on the PCB, whereby the dielectric waveguide 22 is pre-fabricated. The pre-fabricated dielectric waveguide 22 may be formed using, for example, injection molding, vacuum forming, and compression molding. This method of either adhering or mounting the dielectric waveguide 22 is denoted graphically in FIG. 14(d).

It should be noted that when the system 20 is used, less copper is correspondingly used. A single dielectric waveguide is able to replace a plurality of copper tracks. Thus, even when the use of copper for the couplers is taken into consideration, the use of dielectric waveguides is more economical than the use of the plurality of copper tracks.

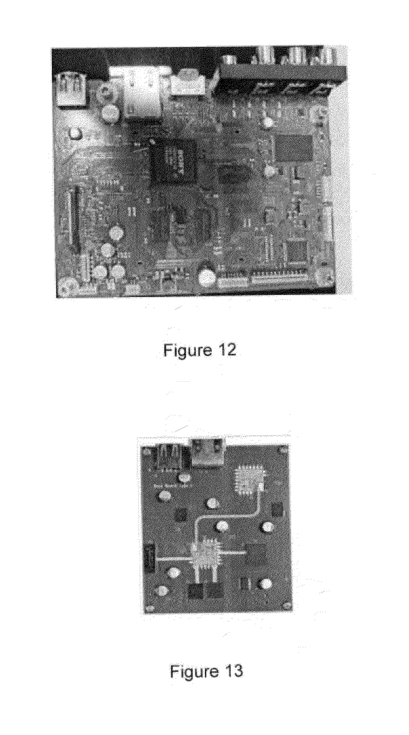

As illustrated in FIGS. 11 and 12, which have identical measurement scales, FIG. 11 shows a PCB board using a plurality of copper tracks for chip-to-chip communications while FIG. 12 shows a PCB board with the same functions as that shown in FIG. 11 using the system 20. The more compact dimensions of the PCB in FIG. 12 as compared to the PCB in FIG. 11 is evident. As such, it is evident that the use of the system 20 results in a smaller footprint on the PCB. It should be appreciated that IC chip and waveguide dimensions also affect a size of the PCB. It should also be noted that the methods for forming the dielectric waveguide 22 enables flexibility in a configuration of a PCB, as the dielectric waveguide 22 can be either removed or reconfigured, and the dielectric waveguide 22 may be formed over existing copper tracks. The aforementioned methods also cost less compared to incorporating a plurality of copper tracks on a PCB.

Whilst the foregoing description has described exemplary embodiments, it will be understood by those skilled in the technology concerned that many variations in details of design, construction and/or operation may be made without departing from the present invention.

1. A method for providing chip-to-chip RF communications on a printed circuit board (PCB), the method including:
providing a dielectric waveguide made from a dielectric material; and
connecting a coupler at each end of the dielectric waveguide, the connecting coupling the dielectric waveguide to at least two chips.

2. The method of claim 1, wherein the dielectric has a cross-sectional shape that is selected from a group consisting of: quadrilateral, circular, semi-circular, elliptical, and polygonal.

3. The method of claim 1, wherein providing the dielectric waveguide comprises a process selected from a group consisting of: printing, injection molding-and-stamping, and etching.

4. The method of claim 2, wherein providing the dielectric waveguide comprises a process selected from a group consisting of: printing, injection molding-and-stamping, and etching.

5. The method of claim 1, wherein the coupler includes:
a microstrip line (MSL) to connect to a contact of a chip; and
a planar horn antenna transitioning from the MSL to the dielectric waveguide.

6. The method of claim 1, wherein the providing the dielectric waveguide further comprises:
printing liquid or semi-liquid dielectric material on the PCB between the couplers; and
solidifying the liquid or semi-liquid dielectric material into the dielectric waveguide.

7. The method of claim 1, wherein the providing the dielectric waveguide further comprises:
injecting dielectric material into a mold; and
stamping the dielectric material from the mold to the PCB between the couplers.

8. The method of claim 1, wherein the providing the dielectric waveguide further comprises:
adhering a layer of dielectric material to the PCB;
cutting excess portions of the dielectric layer; and
removing the excess portions.

9. The method of claim 1, wherein the providing the dielectric waveguide further comprises:
providing a prefabricated dielectric waveguide; and
attaching the prefabricated waveguide to the PCB between the couplers.
